(19) United States
(12) Patent Application Publication
(10) Pub. No.: US 2024/0146399 A1
(43) Pub. Date: May 2, 2024

(54) Device-Driven Communication Handover

(71) Applicant: Apple Inc., Cupertino, CA (US)

(72) Inventors: Sudeep Bhattarai, Hayward, CA (US); Lohit Sarna, San Mateo, CA (US); Nishant Pattanaik, San Diego, CA (US); Seshu Tummala, Cupertino, CA (US); Saurabh Deo, Cupertino, CA (US); Sebastian B. Seeber, San Carlos, CA (US); Venkateswara Rao Manepalli, San Jose, CA (US); Sudhir K. Baghel, Pleasanton, CA (US); Mehran T. Baghaei, San Diego, CA (US); Shahram Talakoub, San Jose, CA (US)

(21) Appl. No.: 17/948,065

(22) Filed: Sep. 19, 2022

(51) Int. Cl. H04B 7/185; H04B 7/195

(52) U.S. Cl. CPC H04B 7/18513; H04B 7/195

(57) ABSTRACT

A communications system may include user equipment (UE) device, satellites, and a gateway. The UE and gateway may perform implicit handover in which the UE and gateway independently identify the same serving satellite using ephemeris data, without additional signaling overhead. The UE may also characterize its channel conditions. When insufficient, the UE may transmit an explicit handover message to the gateway via a different satellite visible to the UE. The explicit handover message may include a satellite identifier and a lock bit. The gateway may use the satellite identifier to convey wireless data with the UE via the different satellite during the next cycle. The gateway may use the lock bit to know how to perform handover away from the different cycle during subsequent cycles. In this way, the UE may direct handover, given that the gateway has no knowledge of the channel condition at the UE.

### FIELD

This relates generally to wireless communications, including wireless communications via one or more satellites.

### BACKGROUND

Communications systems are used to convey data between user equipment devices. Some communications systems include satellites that wirelessly convey data between user equipment devices and gateways. Each satellite provides wireless network access to the user equipment devices located within a corresponding coverage area on Earth.

The satellites can include non-geostationary satellites. If care is not taken, it can be difficult to ensure that the user equipment devices maintain wireless communications with the gateways as the non-geostationary satellites move over time.

### SUMMARY

A communications system may include user equipment (UE) devices, a constellation of communications satellites, gateways, and a core network. The communications satellites may include non-geostationary orbit (NGSO) satellites. The satellites may provide wireless communications services to the UE devices.

A UE device and a gateway may perform an implicit handover operation to agree on which satellite in the constellation will serve as a serving satellite for the UE device during an upcoming communication cycle. The UE device and the gateway may both independently identify, based on ephemeris data for the constellation, the position of the UE device, and a GPS time, the elevation angle of all satellites in the constellation. The UE device and the gateway may then select, as the serving satellite, a default satellite having a highest elevation angle of all satellites that are visible to the UE device. The UE device and the gateway may independently and implicitly continue to communicate via new serving satellites in this manner. This may allow the UE device and the gateway to implicitly and independently handover between satellites without additional control signaling overhead.

The UE device may also gather wireless performance metric data characterizing its current channel condition. When the channel condition is insufficient, the UE device may transmit an explicit handover message to the gateway via a different (e.g., non-default) satellite in the constellation that is visible to the UE device. The explicit handover message may include a satellite identifier associated with the different satellite. The explicit handover message may also include a lock bit. The gateway may use the satellite identifier to convey wireless data with the UE device via the different satellite during the next cycle. When the lock bit has a first value, the gateway and the UE device may continue to communicate via the different satellite until it sets relative to the UE device, at which point implicit handover may be performed. When the lock bit has a second value, the gateway and the UE device may proceed with implicit handover without waiting for the different satellite to set or may convey wireless data via a new default satellite and then proceed with implicit handover. In this way, the UE device may direct handover for the gateway with minimal overhead, despite the gateway having little knowledge of the channel conditions at the UE device.

### BRIEF DESCRIPTION OF THE DRAWINGS

FIG. 1 is a diagram of an illustrative communications system having user equipment devices that communicate with gateways via a constellation of communications satellites in accordance with some embodiments.

FIG. 2 is a schematic diagram of an illustrative user equipment device in accordance with some embodiments.

FIG. 3 is a schematic diagram of an illustrative communications satellite in accordance with some embodiments.

FIG. 4 is a diagram showing how an illustrative communications satellite may communicate using different signal beams within a coverage area in accordance with some embodiments.

FIG. 5 is a diagram showing how signal beams from different satellites may overlap a user equipment device as the satellites move over time in accordance with some embodiments.

FIG. 6 is a flow chart of illustrative operations that may be performed by a user equipment device and a gateway to perform an implicit handover operation between satellites in accordance with some embodiments.

FIG. 7 is a diagram showing how obstacles may block a default satellite from communicating with a user equipment device in accordance with some embodiments.

FIG. 8 is a flow chart of illustrative operations that may be performed by a user equipment device to direct/control an explicit handover operation between satellites in accordance with some embodiments.

FIG. 9 is a flow chart of illustrative operations that may be performed by one or more gateways in performing an explicit handover operation in accordance with some embodiments.

FIG. 10 is a diagram of an illustrative explicit handover message that may be transmitted by a user equipment device to one or more gateways in accordance with some embodiments.

FIG. 11 is a table showing how an illustrative user equipment device and gateway may perform handover away from a new serving satellite as selected by a user equipment device during an explicit handover operation in accordance with some embodiments.

### DETAILED DESCRIPTION

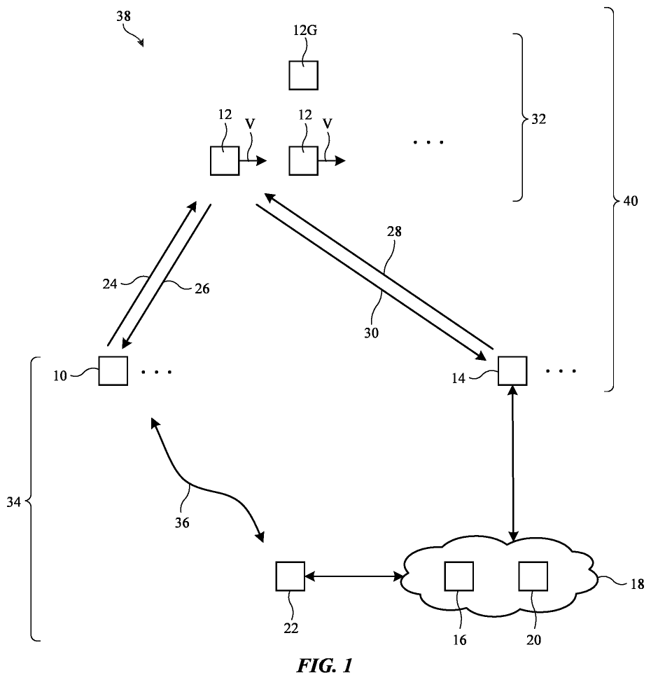

FIG. 1 is a diagram of an illustrative communications system 38. Communications system 38 (sometimes referred to herein as communications network 38, network 38, system 38, satellite communications system 38, or satellite communications network 38) may include a ground-based (terrestrial) gateway system that includes one or more gateways 14 and one or more user equipment (UE) devices 10. Gateways 14 and UE devices 10 may form a part of a terrestrial network 34 on Earth. Terrestrial network 34 may include terrestrial-based wireless communications equipment 22 and network portion 18. Terrestrial-based wireless communications equipment 22 may include one or more wireless base stations (e.g., for implementing a cellular telephone network) and/or wireless access points (e.g., for implementing a wireless local area network).

Communications system 38 may also include a constellation 32 of one or more communications satellites 12 and 12G (sometimes referred to herein simply as satellites 12 and 12G). UE devices 10, gateways 14, and constellation 32 may form a part of non-terrestrial network (NTN) 40, which conveys signals between UE devices 10 and gateways 14 via constellation 32. Constellation 32 may sometimes be referred to herein as satellite constellation 32. Communications satellites 12 and 12G are located in space (e.g., in orbit above Earth). While communications system 38 may include any desired number of gateways 14, any desired number of communications satellites, and any desired number of UE devices 10, only a single gateway 14, three communications satellites, and a single UE device 10 are illustrated in FIG. 1 for the sake of clarity. Each gateway 14 in communications system 38 may be located at a different respective geographic location on Earth (e.g., across different regions, states, provinces, countries, continents, etc.).

Network portion 18 may be communicably coupled to terrestrial-based wireless communications equipment 22 and each of the gateways 14 in communications system 38. Gateway (GW) 14 may include a satellite network ground station and may therefore sometimes also be referred to as ground station (GS) 14 or satellite network ground station 14. Each gateway 14 may include one or more antennas (e.g., electronically and/or mechanically adjustable antennas), modems, transceivers, amplifiers, beam forming circuitry, control circuitry (e.g., one or more processors, storage circuitry, etc.) and other components that are used to convey communications data. The components of each gateway 14 may, for example, be disposed at a respective geographic location (e.g., within the same computer, server, data center, building, etc.). Gateways 14 may convey communications data between terrestrial network 34 and UE devices 10 via satellite constellation 32.

Network portion 18 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, etc.). Network portion 18 may include one or more relay networks, mesh networks, local area networks (LANs), wireless local area networks (WLANs), ring networks (e.g., optical rings), cloud networks, virtual/logical networks, the Internet, combinations of these, and/or any other desired network nodes coupled together using any desired network topologies (e.g., on Earth). The network nodes, terminals, and/or end hosts may include network switches, network routers, optical add-drop multiplexers, other multiplexers, repeaters, modems, servers, network cards, wireless access points, wireless base stations, UE devices such as UE devices 10, and/or any other desired network components. The network nodes in network portion 18 may include physical components such as electronic devices, servers, computers, user equipment, etc., and/or may include virtual components that are logically defined in software and that are distributed across (over) two or more underlying physical devices (e.g., in a cloud network configuration).

Network portion 18 may include one or more satellite network operations centers such as network operations center (NOC) 16. NOC 16 may control the operation of gateways 14 in communicating with satellite constellation 32. NOC 16 may also control the operation of the satellites in satellite constellation 32. For example, NOC 16 may convey control commands via gateways 14 that control positioning operations (e.g., orbit adjustments), sensing operations (e.g., thermal information gathered using one or more thermal sensors), and/or any other desired operations performed in space by satellites 12. NOC 16, gateways 14, and satellite constellation 32 may be operated or managed by a corresponding satellite constellation operator.

Communications system 38 may also include a satellite communications (satcom) network service provider (e.g., a satcom network carrier or operator) for controlling wireless communications between UE devices 10 and terrestrial network 34 via satellite constellation 32. The satcom network service provider may be a different entity than the satellite constellation operator that controls/operates NOC 16, gateways 14, and satellite constellation 32 or, if desired, may be the same entity as the satellite constellation operator. Terrestrial-based wireless communications equipment 22 in terrestrial network 34 may be operated by one or more terrestrial network carriers or service providers. The terrestrial network carriers or service providers may be different entities than the satcom network service provider or, if desired, may be the same entity as the satcom network service provider.

One or more gateways 14 may control the operations of satellite constellation 32 over corresponding radio-frequency communications links. Satellite constellation 32 may include any desired number of satellites (e.g., two satellites, four satellites, ten satellites, dozens of satellites, hundreds of satellites, thousands of satellites, etc.), three of which are shown in FIG. 1. If desired, two or more of the satellites in satellite constellation 32 may convey radio-frequency signals between each other using satellite-to-satellite (e.g., relay) links.

Constellation 32 may include a set of non-geostationary orbit (NGSO) satellites (e.g., satellites in non-geostationary orbits) and, if desired, may include a set of geostationary orbit (GSO) satellites (e.g., satellites in geostationary/geosynchronous orbits, sometimes referred to as geosynchronous satellites or GEO satellites). The satellites 12 of constellation 32 as described herein are NGSO satellites (e.g., satellites 12 may be in NGSO orbits and may sometimes be referred to herein as NGSO satellites 12). Satellites 12 therefore move relative to the surface of Earth over time (e.g., at velocities V relative to the surface of Earth). The satellites 12G of constellation 32 are GSO satellites (e.g., satellites 12G may be in GSO orbits and may sometimes be referred to herein as GSO satellites 12G). GSO satellites 12G do not move relative to the surface of Earth (e.g., GSO satellites 12G may orbit around Earth at a velocity that matches the rotation of Earth given the altitude of the satellites).

GSO satellites 12G may orbit Earth at orbital altitudes of greater than around 30,000 km. Satellites 12 may include low earth orbit (LEO) satellites at orbital altitudes of less than around 8,000 km (e.g., satellites in low earth orbits, inclined low earth orbits, low earth circular orbits, etc.), medium earth orbit (MEO) satellites at orbital altitudes between around 8,000 km and 30,000 km (e.g., satellite in medium earth orbits), sun synchronous satellites (e.g., satellites in sun synchronous orbits), satellites in tundra orbits, satellites in Molniya orbits, satellites in polar orbits, and/or satellites in any other desired non-geosynchronous orbits around Earth. If desired, satellites 12 may include multiple sets of satellites each in a different type of orbit and/or each at a different orbital altitude. In general, constellation 32 may include satellites in any desired combination of orbits or orbit types.

The satellites 12 and 12G in constellation 32 may communicate with one or more UE devices 10 on Earth using one or more radio-frequency communications links (e.g., satellite-to-user equipment links). Satellites 12 and 12G may also communicate with gateways 14 on Earth using radio-frequency communications links (e.g., satellite-to-gateway links). Radio-frequency signals may be conveyed between UE devices 10 and satellites 12/12G and between satellites 12/12G and gateways 14 in IEEE bands such as the IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), and/or any other desired satellite communications bands. If desired, different bands may be used for the satellite-to-user equipment links than for the satellite-to-gateway links.

Communications may be performed between gateways 14 and UE devices 10 in a forward (FWD) link direction and/or in a reverse (REV or RWD) link direction. In the forward link direction (sometimes referred to simply as the forward link), wireless data is conveyed from gateways 14 to UE device(s) 10 via satellite constellation 32. For example, a gateway 14 may transmit forward link data to one of the satellites 12 in satellite constellation 32 (e.g., using radio-frequency signals 28). Satellite 12 may transmit (e.g., relay, in a bent-pipe configuration) the forward link data received from gateway 14 to UE device(s) 10 (e.g., using radio-frequency signals 26). Radio-frequency signals 28 are conveyed in an uplink direction from gateway 14 to satellite 12 and may therefore sometimes be referred to herein as uplink (UL) signals 28, forward link UL signals 28, or forward link signals 28. Radio-frequency signals 26 are conveyed in a downlink direction from satellite 12 to UE device(s) 10 and may therefore sometimes be referred to herein as downlink (DL) signals 26, forward link DL signals 26, or forward link signals 26.

In the reverse link direction (sometimes referred to simply as the reverse link), wireless data is conveyed from UE device(s) 10 to gateways 14 via satellite constellation 32. For example, one of the UE devices 10 may transmit reverse link data to one of the satellites 12 in constellation 32 using radio-frequency signals 24 and satellite 12 may transmit (e.g., relay, in a bent-pipe configuration) the reverse link data received from UE device 10 to a corresponding gateway 14 using radio-frequency signals 30. Radio-frequency signals 24 are conveyed in an uplink direction from UE device 10 to satellite 12 and may therefore sometimes be referred to herein as uplink (UL) signals 24, reverse link UL signals 24, or reverse link signals 24. Radio-frequency signals 30 are conveyed in a downlink direction from satellite 12 to gateway 14 and may therefore sometimes be referred to herein as downlink (DL) signals 30, reverse link DL signals 30, or reverse link signals 30. Gateway 14 may forward wireless data between UE device(s) 10 and network portion 18. Network portion 18 may forward the wireless data to any desired network nodes or terminals of terrestrial network 34.

If desired, UE devices 10 may also convey radio-frequency signals with terrestrial-based wireless communications equipment 22 over terrestrial network wireless communication links 36 when available. UE devices 10 may sometimes be referred to herein as being “online” or “on-grid” when the UE devices are within range of terrestrial-based wireless communications equipment 22 and when terrestrial-based wireless communications equipment 22 provides access (e.g., communications resources) to network portion 18 for the UE devices. When the UE devices are online, the UE devices may communicate with other network nodes or terminals in network portion 18 via terrestrial network wireless communications links 36. Conversely, UE devices 10 may sometimes be referred to herein as being “offline” or “off-grid” when the UE devices are out of range of terrestrial-based wireless communications equipment 22 or when terrestrial-based wireless communications equipment 22 does not provide access to network portion 18 for the UE devices (e.g., when terrestrial-based wireless communications equipment 22 is disabled due to a power outage, natural disaster, traffic surge, or emergency, when terrestrial-based wireless communications equipment 22 denies access to network portion 18 for the UE devices, when terrestrial-based wireless communications equipment 22 is overloaded with traffic, etc.).

If desired, UE devices 10 may include separate antennas for handling communications over the satellite-to-user equipment link and one or more terrestrial network wireless communication links 36 or UE devices 10 may include a single antenna that handles both the satellite-to-user equipment link and the terrestrial network wireless communications links. The terrestrial network wireless communications links may be, for example, cellular telephone links (e.g., links maintained using a cellular telephone communications protocol such as a 4G Long Term Evolution (LTE) protocol, a 3G protocol, a 3GPP Fifth Generation (5G) New Radio (NR) protocol, etc.), wireless local area network links (e.g., Wi-Fi® and/or Bluetooth links), etc.

The wireless data conveyed in DL signals 26 may sometimes be referred to herein as DL data, forward link DL data, or forward link data. UL signals 28 may also convey the forward link data (e.g., forward link data that is routed by satellite 12 to UE device(s) 10 in DL signals 26). The wireless data conveyed in UL signals 24 may sometimes be referred to herein as UL data, reverse link UL data, or reverse link data. The reverse link data may be generated by UE device(s) 10. DL signals 30 may also convey the reverse link data. The forward link data may be generated by any desired network nodes or terminals of terrestrial network 34. The forward link data and the reverse link data may include text data such as email messages, text messages, web browser data, an emergency or SOS message, a location message identifying the location of UE device(s) 10, or other text-based data, audio data such as voice data (e.g., for a bi-directional satellite voice call) or other audio data (e.g., streaming satellite radio data), video data (e.g., for a bi-directional satellite video call or to stream video data transmitted by gateway 14 at UE device(s) 10), cloud network synchronization data, data generated or used by software applications running on UE device(s) 10, data for use in a distributed processing network, and/or any other desired data. UE devices 10 may only receive forward link data, may only transmit reverse link data, or may both transmit reverse link data and receive forward link data. Each satellite 12/12G may communicate with the UE devices 10 located within its coverage area (e.g., UE devices 10 located within cells on Earth that overlap the signal beam(s) producible by the satellite).

The satcom network service provider for communications system 38 may operate, control, and/or manage a satcom control network such as core network (CN) 20 in network portion 18. CN 20 may sometimes also be referred to herein as satcom network region 20, CN region 20, satcom controller 20, satcom network 20, or satcom service provider equipment 20. CN 20 may be implemented on one or more network nodes and/or terminals of network portion 18 (e.g., one or more servers or other end hosts). In some implementations, CN 20 may be formed from a cloud computing network distributed over multiple underlying physical network nodes and/or terminals distributed across one or more geographic regions. CN 20 may therefore sometimes also be referred to herein as a CN cloud region or satcom network cloud region.

CN 20 may control and coordinate wireless communications between terminals of terrestrial network 34 and UE devices 10 via satellite constellation 32. For example, gateways 14 may receive reverse link data from UE devices 10 via satellite constellation 32 and may route the reverse link data to CN 20. CN 20 may perform any desired processing operations on the reverse link data. For example, CN 20 may identify destinations for the reverse link data and may forward the reverse link data to the identified destinations. CN 20 may also receive forward link data for transmission to UE devices 10 from one or more terminals (end hosts) of terrestrial network 34 (e.g., network portion 18). CN 20 may process the forward link data to schedule the forward link data for transmission to UE devices 10 via satellite constellation 32. CN 20 may schedule the forward link data for transmission to UE devices 10 by generating forward link traffic grants for each of the UE devices that are to receive forward link data. CN 20 may provide the forward link data and the forward link traffic grants to gateways 14. Gateways 14 may transmit the forward link data to UE devices 10 via satellite constellation 32 according to the forward link traffic grants (e.g., according to a forward link communications schedule that implements the forward link traffic grants). CN 20 may include, be coupled to, and/or be associated with one or more content delivery networks (CDNs) that provide content for delivery to UE devices 10.

UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

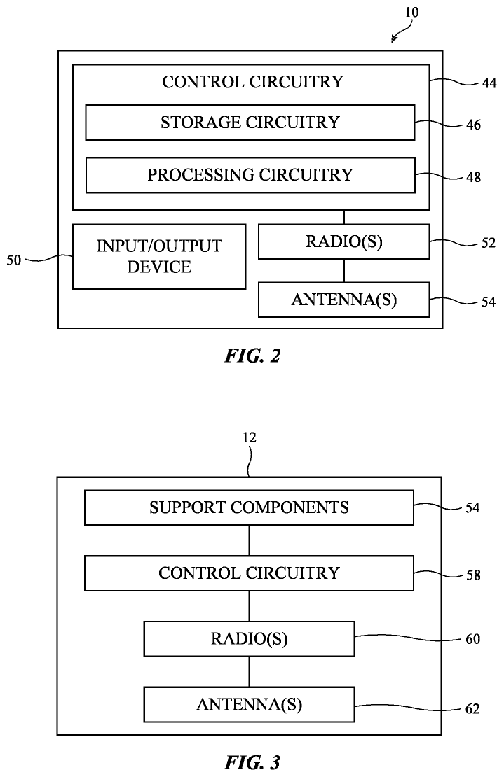

As shown in FIG. 2, UE device 10 may include components located on or within an electronic device housing such as housing 42. Housing 42, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 42 may be formed from dielectric or other low-conductivity material (e.g., glass, ceramic, plastic, sapphire, etc.). In other situations, housing 42 or at least some of the structures that make up housing 42 may be formed from metal elements.

UE device 10 may include control circuitry 44. Control circuitry 44 may include storage such as storage circuitry 46. Storage circuitry 46 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 46 may include storage that is integrated within UE device 10 and/or removable storage media.

Control circuitry 44 may include processing circuitry such as processing circuitry 48. Processing circuitry 48 may be used to control the operation of UE device 10. Processing circuitry 48 may include on one or more processors (e.g., microprocessors, microcontrollers, digital signal processors, host processors, baseband processor integrated circuits, application specific integrated circuits, central processing units (CPUs), graphics processing units (GPUs), etc.). Control circuitry 44 may be configured to perform operations in device 10 using hardware (e.g., dedicated hardware or circuitry), firmware, and/or software. Software code for performing operations on UE device 10 may be stored on storage circuitry 46 (e.g., storage circuitry 46 may include non-transitory (tangible) computer readable storage media that stores the software code). The software code may sometimes be referred to as program instructions, software, data, instructions, or code. Software code stored on storage circuitry 46 may be executed by processing circuitry 48.

Control circuitry 44 may be used to run software on UE device 10 such as satellite navigation applications, internet browsing applications, voice-over-internet-protocol (VOIP) telephone call applications, email applications, media playback applications, operating system functions, etc. To support interactions with external equipment, control circuitry 44 may be used in implementing communications protocols. Communications protocols that may be implemented using control circuitry 44 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 5G protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), satellite communications protocols, or any other desired communications protocols. Each communications protocol may be associated with a corresponding radio access technology (RAT) that specifies the physical connection methodology used in implementing the protocol.

UE device 10 may store satellite information associated with one or more of the satellites 12 in satellite constellation 32 on storage circuitry 46. The satellite information, sometimes referred to herein as ephemeris data or ephemeris information, may include a satellite almanac identifying the orbital parameters/position (e.g., orbit information, elevation information, altitude information, inclination information, eccentricity information, orbital period information, trajectory information, right ascension information, declination information, ground track information, etc.) and/or the velocity of satellites 12 (e.g., relative to the surface of Earth). This information may include a two-line element (TLE), for example. The TLE may identify (include) information about the orbital motion of one or more of the satellites 12 in satellite constellation 32 (e.g., satellite epoch, first and/or second derivatives of motion, drag terms, etc.). The TLE may be in the format of a text file having two lines or columns that include the set of elements forming the TLE, for example. Control circuitry 44 may use the ephemeris data to calculate, predict, or identify the location of satellites 12 at a given point in time.

UE device 10 may also include wireless circuitry to support wireless communications. The wireless circuitry may include one or more antennas 54 and one or more radios 52. Each radio 52 may include circuitry that operates on signals at baseband frequencies (e.g., baseband processor circuitry), signal generator circuitry, modulation/demodulation circuitry (e.g., one or more modems), radio-frequency transceiver circuitry (e.g., radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, etc.), amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, and/or any other circuitry for transmitting and/or receiving radio-frequency signals using antenna(s) 54. The components of each radio 52 may be mounted onto a respective substrate or integrated into a respective integrated circuit, chip, package, or system-on-chip (SOC). If desired, the components of multiple radios 52 may share a single substrate, integrated circuit, chip, package, or SOC.

Antenna(s) 54 may be formed using any desired antenna structures. For example, antenna(s) 54 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas 54 may include antenna resonating elements formed from conductive portions of housing 42 (e.g., peripheral conductive housing structures extending around a periphery of a display on UE device 10). Filter circuitry, switching circuitry, impedance matching circuitry, and/or other antenna tuning components may be adjusted to adjust the frequency response and wireless performance of antenna(s) 54 over time. If desired, multiple antennas 54 may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Transceiver circuitry in radios 52 may convey radio-frequency signals using one or more antennas 54 (e.g., antenna(s) 54 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antenna(s) 54 may transmit the radio-frequency signals by radiating the radio-frequency signals into free space (or to free space through intervening device structures such as a dielectric cover layer). Antenna(s) 54 may additionally or alternatively receive the radio-frequency signals from free space (e.g., through intervening devices structures such as a dielectric cover layer). The transmission and reception of radio-frequency signals by antenna(s) 54 each involve the excitation or resonance of antenna currents on an antenna resonating element in the antenna by the radio-frequency signals within the frequency band(s) of operation of the antenna.

Each radio 52 may be coupled to one or more antennas 54 over one or more radio-frequency transmission lines. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios 52 if desired. Radio-frequency front end (RFFE) modules may be interposed on one or more of the radio-frequency transmission lines. The radio-frequency front end modules may include substrates, integrated circuits, chips, or packages that are separate from radios 52 and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Radios 52 may use antenna(s) 54 to transmit and/or receive radio-frequency signals within different frequency bands at radio frequencies (sometimes referred to herein as communications bands or simply as a “bands”). The frequency bands handled by radios 52 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

While control circuitry 44 is shown separately from radios 52 in the example of FIG. 2 for the sake of clarity, radios 52 may include processing circuitry that forms a part of processing circuitry 48 and/or storage circuitry that forms a part of storage circuitry 46 of control circuitry 44 (e.g., portions of control circuitry 44 may be implemented on radios 52). As an example, control circuitry 44 may include baseband circuitry or other control components that form a part of radios 52. The baseband circuitry may, for example, access a communication protocol stack on control circuitry 44 (e.g., storage circuitry 46) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

UE device 10 may include input-output devices 50. Input-output devices 50 may be used to allow data to be supplied to UE device 10 and to allow data to be provided from UE device 10 to external devices. Input-output devices 50 may include user interface devices, data port devices, and other input-output components. For example, input-output devices 50 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 50 may be peripherals that are coupled to a main processing unit or other portion of device 10 via a wired or wireless link). UE device 10 may be owned and/or operated by an end user.

FIG. 3 is a diagram of an illustrative satellite 12 in communications system 38. As shown in FIG. 3, satellite 12 may include satellite support components 56. Support components 56 may include batteries, solar panels, sensors (e.g., accelerometers, gyroscopes, temperature sensors, light sensors, etc.), guidance systems, propulsion systems, and/or any other desired components associated with supporting satellite 12 in orbit above Earth.

Satellite 12 may include control circuitry 58. Control circuitry 58 may be used in controlling the operations of satellite 12. Control circuitry 58 may include processing circuitry such as processing circuitry 48 of FIG. 2 and may include storage circuitry such as storage circuitry 46 of FIG. 2. Control circuitry 58 may also control support components 56 to adjust the trajectory or position of satellite 12 in space.

Satellite 12 may include antennas 62 and one or more radios 60. Radios 60 may use antennas 62 to transmit DL signals 26 and DL signals 30 and to receive UL signals 24 and UL signals 28 of FIG. 1 (e.g., in one or more satellite communications bands). Radios 60 may include transceivers, modems, integrated circuit chips, application specific integrated circuits, filters, switches, up-converter circuitry, down-converter circuitry, analog-to-digital converter circuitry, digital-to-analog converter circuitry, amplifier circuitry (e.g., multiport amplifiers), beam steering circuitry, etc.

Antennas 62 may include any desired antenna structures (e.g., patch antenna structures, dipole antenna structures, monopole antenna structures, waveguide antenna structures, Yagi antenna structures, inverted-F antenna structures, cavity-backed antenna structures, combinations of these, etc.). In one suitable arrangement, antennas 62 may include one or more phased array antennas. Each phased array antenna may include beam forming circuitry having a phase and magnitude controller coupled to each antenna element in the phased array antenna. The phase and magnitude controllers may provide a desired phase and magnitude to the radio-frequency signals conveyed over the corresponding antenna element. The phases and magnitudes of each antenna element may be adjusted so that the radio-frequency signals conveyed by each of the antenna elements constructively and destructively interfere to produce a radio-frequency signal beam (e.g., a spot beam) in a desired pointing direction (e.g., an angular direction towards Earth at which the radio-frequency signal beam exhibits peak gain). Radio-frequency lenses may also be used to help guide the radio-frequency signal beam in a desired pointing direction. Each radio-frequency signal beam also exhibits a corresponding beam width. This allows each radio-frequency signal beam to cover a corresponding area on Earth (e.g., a region on Earth overlapping the radio-frequency signal beam such that the radio-frequency signal beam exhibits a power greater than a minimum threshold value within that region/cell). Satellite 12 may convey radio-frequency signals over multiple concurrently-active signal beams if desired. If desired, satellite 12 may offload some or all of its beam forming operations to gateway 14. The signal beams may sometimes be referred to herein simply as beams.

If desired, radios 60 and antennas 62 may support communications using multiple polarizations. For example, radios 60 and antennas 62 may transmit and receive radio-frequency signals with a first polarization (e.g., a left-hand circular polarization (LHCP)) and may transmit and receive radio-frequency signals with a second polarization (e.g., a right-hand circular polarization (RHCP)). Antennas 62 may be able to produce a set of different signal beams at different beam pointing angles (e.g., where each beam overlaps a respective cell on Earth). The set of signal beams may include a first subset of signal beams that convey LHCP signals (e.g., LHCP signal beams) and a second subset of signal beams that convey RHCP signals (e.g., RHCP signal beams). The LHCP and RHCP signal beams may, for example, be produced using respective multiport power amplifiers (MPAs) on satellite 12. This is merely illustrative and, in general, satellite 12 may produce any desired number of signal beams having any desired polarizations.

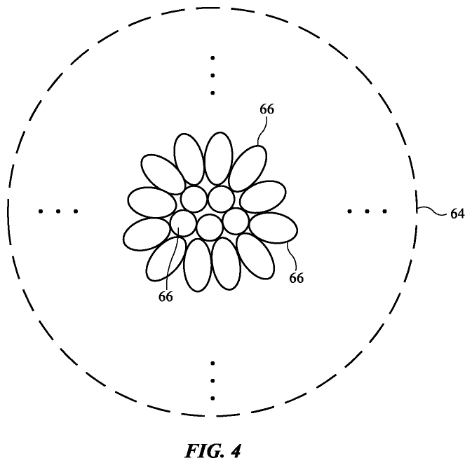

FIG. 4 is a top-down diagram (e.g., a bird's eye view of the surface of Earth) showing how a given satellite 12 may convey radio-frequency signals over different beams. As shown in FIG. 4, satellite 12 may convey radio-frequency signals within a set of beams 66 (e.g., a set of beams formable by the antennas 62 on satellite 12). The set may include any desired number of beams 66 (e.g., two beams, 2-16 beams, tens of beams, dozens of beams, hundreds of beams, thousands of beams, etc.). Each beam 66 may be oriented in a different respective beam pointing direction. As such, each beam 66 may overlap a different respective area on Earth (sometimes referred to herein as spot beams, beam footprints, or footprints). The footprints of beams 66 on Earth are illustrated in FIG. 4. UE devices 10 that overlap the footprint of a given beam 66 may sometimes be referred to as being in, within, or of that beam 66. All of the beams 66 may collectively cover a coverage area or region 64 on Earth.

Beams 66 that are located farther from boresight (e.g., the center of region 64) may have a more elongated or distorted shape and may therefore cover more area on Earth than beams 66 that are located closer to boresight. To provide that each of the beams 66 across region 64 with uniform power density, satellite 12 may transmit radio-frequency signals with higher transmit power levels in beams 66 at higher elevation angles (e.g., beams farther from boresight) than in beams 66 at lower elevation angles. Satellite 12 may transmit and/or receive radio-frequency signals within one or more beam 66 at a given time. Since the amount of power on satellite 12 is finite, satellite 12 may form beams 66 with more power-per-beam when fewer beams 66 are concurrently active than when more beams 66 are concurrently active. In general, satellite 12 may serve different beam footprints using any desired combination of spatial multiplexing, time multiplexing, and frequency multiplexing. Satellite 12 may, for example, perform a time-division duplexing beam hopping operation to selectively activate different beams 66 at any given time until each beam 66 in region 64 has been active at least once for a given period. This beam hopping operation may be performed according to a beam hopping schedule that dictates which beams are active at different times (e.g., the order and duration of activation (dwell time) for each beam). By selectively activating each of the beams at different times, the entire region 64 may be covered by satellite 12 with sufficiently high power-per-beam.

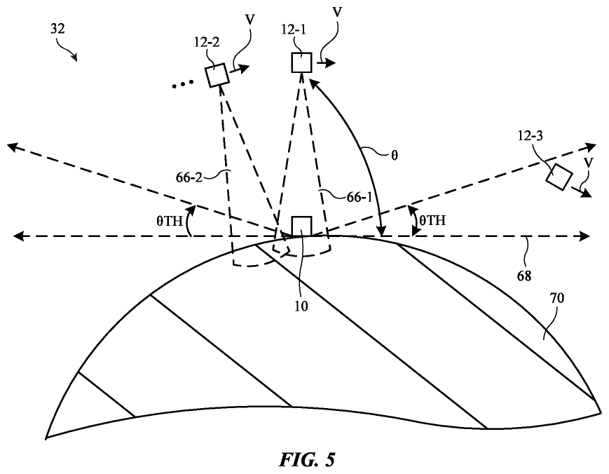

Satellites 12 move with respect to Earth over time. As such, different satellites 12 will have beams 66 overlapping UE device 10 at different times. FIG. 5 is a diagram showing how different satellites 12 may have beams 66 overlapping UE device 10 at different times. As shown in FIG. 5, UE device 10 may be located on Earth 70. At a first time, UE device 10 may be located within a beam 66-1 of a first satellite 12-1. As satellite 12-1 moves over time with respect to the location of UE device 10 (e.g., at velocity V), satellite 12-1 may, if desired, perform a handover operation between different beams of satellite 12-1 to ensure that UE device 10 remains able to communicate via satellite 12-1. However, eventually satellite 12-1 will have no beams that overlap UE device 10 and a different satellite may be used to convey wireless data between UE device 10 and one or more gateways.

Put generally, at the first time there may be a second satellite 12-2 having beam 66-2 that does not overlap UE device 10 on Earth 70. Second satellite 12-2 may also be moving at velocity V relative to UE device 10. However, at a second time, satellite 12-2 may have moved such that UE device 10 overlaps beam 66-2. Beam 66-2 and satellite 12-2 may then be used to convey wireless data between UE device 10 and one or more gateways. Changing the active beam used by UE device 10 to communicate with the one or more gateways (sometimes referred to herein as the serving beam) may involve a process referred to as handover.

Handover may be performed between beams of a single satellite 12 and/or between beams on different satellites 12. The satellite having the serving beam may sometimes be referred to herein as the serving satellite. A handover operation may be performed to change the serving beam and, if desired, the serving satellite to ensure that UE device 10 is able to continue communicating with the one or more gateways as the satellites move over time. UE device 10 may pass into or out of different signal beams over time due to the motion of satellites 12 relative to the surface of Earth, due to the motion of UE device 10 relative to the surface of the Earth (e.g., when UE device 10 is in motion), and/or due to the rotation of the Earth about its axis.

The position of each satellite 12 relative to UE device 10 may be characterized by an elevation angle θ with respect to the horizon 68 of UE device 10. Satellites 12 that are located at an elevation angle θ that is less than a threshold elevation angle θTH may sometimes be referred to herein as non-visible satellites (e.g., satellites that are not visible to UE device 10). Non-visible satellites either offer no wireless service to UE device 10 or insufficient wireless performance to UE device 10. This is because non-visible satellites have excessive path lengths to UE device 10, such that UL and DL signals conveyed between the UE device and the non-visible satellites are subject to excessive attenuation (e.g., as the signals pass through the Earth's atmosphere). In addition, obstacles on the surface of Earth such as mountains, hills, cliffs, or other landscape features and/or tall buildings, walls, furniture, or other obstacles are more likely to block UL and DL signals conveyed between the UE device and non-visible satellites. In the example of FIG. 5, satellite 12-3 is located at an elevation angle less than threshold elevation angle θTH. Satellite 12-3 therefore forms a non-visible satellite for UE device 10.

On the other hand, satellites 12 that are located at an elevation angle θ that is greater threshold elevation angle θTH may sometimes be referred to herein as visible satellites (e.g., satellites that are visible to UE device 10). These satellites are more likely to offer sufficient wireless capacity to UE device 10 than non-visible satellites (e.g., due to the lesser pathlength between visible satellites and UE device 10, the presence of less atmosphere between UE device 10 and the visible satellites, the low likelihood that obstacles will block the line-of-sight (LOS) path between the visible satellites and UE device 10, etc.). In the example of FIG. 5, satellites 12-1 and 12-2 are located at elevation angles θ greater than threshold elevation angle θTH. Satellites 12-1 and 12-2 therefore form visible satellites for UE device 10. Threshold elevation angle θTH may also sometimes be referred to herein as a satellite visibility threshold. Threshold elevation angle θTH may be, for example, 15 degrees, 20 degrees, 10 degrees, 5 degrees, 30 degrees, 5-30 degrees, 5-20 degrees, 10-20 degrees, 1-10 degrees, 1-20 degrees, or other angles. The visible satellite at the highest elevation angle (e.g., the elevation angle at or closest to 90 degrees or boresight) may sometimes be referred to herein as the default satellite for UE device 10.

To begin and maintain communication between UE device 10 and a gateway 14, both UE device 10 and the gateway need to jointly agree on which satellite is the serving satellite for UE device 10. This is because both UE device 10 and the gateway need to adjust their transmitters and/or receivers based on which satellite 12 in satellite constellation 32 is the serving satellite, in a manner that accounts for the specific radio-frequency propagation conditions between UE device 10 and the serving satellite and between the serving satellite and the one or more gateways. The radio-frequency propagation conditions may include path lengths and doppler shifts, as two examples.

Different satellites 12 will have different path lengths with respect to UE device 10 and with respect to the gateway at different points in time, as the satellites move through space. For example, when transmitting signals to a serving satellite, the UE device and the gateway need to transmit the signals using timing delays that account for the amount of time it takes the transmitted signals to reach the expected location of the serving satellite at a particular time (e.g., the timing delays may be selected such that the transmitted signals arrive at the serving satellite within a scheduled or expected timeslot). If the UE device and the gateway do not agree on which satellite is the serving satellite, the transmitted signals might not be transmitted with the appropriate timing delays, thereby causing the transmitted signals to be improperly synchronized to the satellites and thus not properly received.

At the same time, the velocity of satellites 12 relative to the UE device and the gateway may introduce doppler shifts to the transmitted signals that shift the signals away from an intended frequency. When transmitting signals, the UE device and the gateway may apply a frequency shift to the transmitted signals to compensate for the doppler shifts, thereby ensuring the signals are received at the satellite at a scheduled or expected frequency. If the UE device and the gateway do not agree on which satellite is the serving satellite, the transmitted signals might not be transmitted with the appropriate frequency shifts, thereby causing the transmitted signals to arrive at the satellite at the wrong frequency and thus not properly received. The time delays and frequency shifts used to transmit signals to a given satellite may sometimes be referred to collectively herein as the propagation parameters for that satellite (e.g., where the UE device and the gateway(s) most likely have different propagation parameters for the same satellite given the geographic separation between the UE device and the gateway(s)).

In some implementations, the UE device and the gateway may jointly agree on which satellite is or will be the serving satellite by conveying additional control signals via satellite constellation 32. However, the wireless resources of satellites 12 and UE device 10 are often very limited. Allocating additional resources for this type of signaling can further strain the already-constrained communications system. At the same time, while the gateway may have knowledge of the geographic location of UE device 10 (e.g., via information transmitted to the gateway by UE device 10 and/or knowledge of which beam(s) 66 of satellite constellation 32 are overlapping or have previously overlapped UE device 10), the gateway generally has no real-time information about the radio-frequency channel conditions at UE device 10. For example, there may be obstacles present between UE device 10 and one or more of the satellites or other factors affecting how UE device 10 conveys radio-frequency signals with satellite constellation 32.

In general, UE device 10 may have knowledge of these factors by actively measuring its own channel conditions (e.g., by gathering wireless performance metric data from DL signals received from satellite constellation 32). On the other hand, gateway 14 does not have knowledge of these factors unless and until UE device 10 transmits a report to gateway 14 (e.g., via satellite constellation 32) informing the gateway of its channel conditions. However, the UE device may not have sufficient resources to send physical layer channel feedback information to the gateway for use in agreeing upon the serving satellite. It may therefore be desirable to provide a system or method for UE device 10 and gateway 14 to both convey wireless data via the same serving satellite 12 in a manner that minimizes impact to the constrained resources of the system. In addition, UE device 10 and gateway 14 need to be able to perform handover operations under these constraints such that the UE device and the gateway continue to agree upon the serving satellite, thereby maintaining a continuous and uninterrupted wireless link between the UE device and the gateway throughout the duration of a communication session.

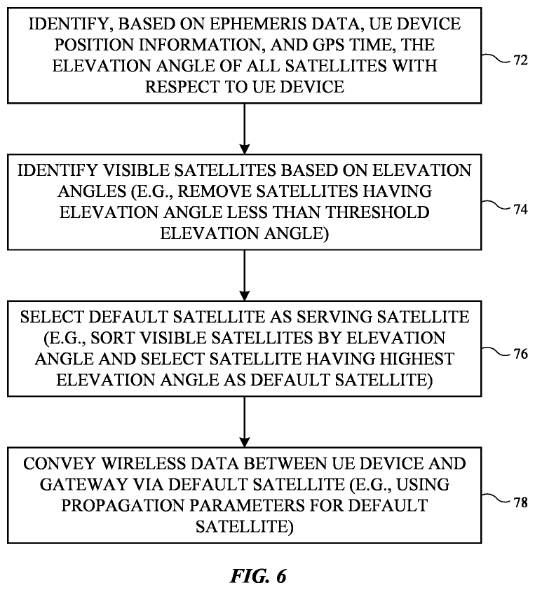

To mitigate these issues while allowing UE device 10 and gateway 14 to maintain an uninterrupted link throughout the duration of the communication session, UE device 10 and gateway 14 may perform two different types of handover operations: an implicit handover operation and, when necessary, an explicit handover operation. FIG. 6 is a flow chart of illustrative operations involved in performing an implicit handover operation using UE device 10 and one or more gateways 14. The implicit handover operation may be used to begin and/or continue wireless communications between UE device 10 and the one or more gateways without additional signaling overhead between UE device 10 and the gateway(s).

At operation 72, UE device 10 may identify the current elevation angle θ (or the expected elevation angle θ at a given future time) for each satellite 12 in satellite constellation 32 with respect to its current location. UE device 10 may identify the elevation angle θ of each satellite 12 based on the ephemeris data for satellite constellation 32 stored at UE device 10 (e.g., from a TLE or other information identifying satellite orbital parameters), the current location or expected future location of UE device 10 (e.g., as determined by a satellite navigation receiver such as a GPS receiver and/or one or more sensors such as motion or location sensors on UE device 10), and a universal time such as the GPS time (e.g., as identified from GPS signals received by the satellite navigation receiver).

At the same time (e.g., concurrently), the one or more gateways 14 may identify the current elevation angle θ (or the expected elevation angle θ at a given future time) for each satellite 12 in satellite constellation 32 at the location of UE device 10. Gateway(s) 14 may identify the elevation angle θ of each satellite 12 based on the ephemeris data for satellite constellation 32 stored at the gateway, the current location or expected future location of UE device 10, and a universal time such as the GPS time. Gateway(s) 14 may have knowledge of the location of UE device 10 based on a registration packet received from UE device 10 via satellite constellation 32 at the beginning of the communication session. UE device 10 may, for example, include information identifying its current location in the registration packet and may transmit the registration packet to the gateway(s) via satellite constellation 32.

At operation 74, UE device 10 may identify which of the satellites 12 in satellite constellation 32 are visible to UE device 10 (or are expected to be visible at a given future time). UE device 10 may, for example, eliminate, remove, or filter out (non-visible) satellites 12 at elevation angles θ for the current location of UE device 10 that are less than threshold elevation angle θTH. At the same time, gateway(s) 14 may identify which of the satellites 12 in satellite constellation 32 are visible to UE device 10 (or are expected to be visible at a given future time). Gateway(s) 14 may, for example, eliminate, remove, or filter out (non-visible) satellites 12 at elevation angles θ for the current location of UE device 10 that are less than threshold elevation angle θTH.

At operation 76, UE device 10 may select the default satellite 12 (e.g., the visible satellite 12 having the highest elevation angle) to be the serving satellite for communicating with gateway(s) 14. For example, UE device 10 may sort the visible satellites 12 by elevation angle and may select the visible satellite 12 having the highest elevation angle as the serving satellite. At the same time, gateway(s) 14 may select the default satellite 12 (e.g., the visible satellite 12 having the highest elevation angle) to be the serving satellite for communicating with UE device 10. For example, UE device 10 may sort the visible satellites for UE device 10 by elevation angle and may select the visible satellite having the highest elevation angle as the serving satellite. In this way, UE device 10 and gateway(s) 14 have both agreed upon the serving satellite for UE device 10 without exchanging any additional control signals between the gateway(s) and the UE device.

At operation 78, UE device 10 and gateway(s) 14 may convey wireless data (e.g., one or more data packets) via the serving satellite (e.g., the default satellite). UE device 10 and gateway(s) 14 may transmit the wireless data using their propagation parameters for the serving satellite (e.g., the default satellite). Since UE device 10 and gateway(s) 14 have agreed upon the same serving satellite (e.g., the default satellite), the propagation parameters will be correctly synchronized between the UE device and the gateway(s), thereby ensuring proper reception of the wireless data at the serving satellite, the UE device, and the gateway(s).

Operations 72-76 of FIG. 6 may be performed during every communication cycle to identify the serving satellite for the next communications cycle. Operation 78 may be performed during the next communications cycle while operations 72-76 are concurrently performed for the subsequent communications cycle. The communications cycle may be, for example, 2.56 seconds or other values. When the default satellite and thus the serving satellite changes for UE device 10, both the UE device and the gateway(s) will implicitly agree upon the new serving satellite and will therefore transmit signals to the new serving satellite during the next cycle (e.g., the next iteration of operation 78) using the correct propagation parameters for the new serving satellite. This process may form an implicit handover operation of UE device 10 from a first serving satellite to a second serving satellite (e.g., when a default satellite no longer has the highest elevation angle among the visible satellites for UE device 10 and thus is no longer the default satellite for UE device 10).

The implicit handover operation occurs without any additional signaling between UE device 10 and gateway(s) 14 (e.g., without transmitting a control message from gateway(s) 14 to UE device 10 via the satellite constellation to instruct UE device 10 when switch to communicating via a different satellite or instructing the UE device on which satellite to switch to, without transmitting a control message from UE device 10 to gateway(s) 14 via the satellite constellation to instruct the gateway(s) when switch to communicating via a different satellite or instructing the gateway(s) on which satellite to switch to, etc.). In this way, the resource overhead required for UE device 10 to maintain its communication link with gateway(s) 14 may be minimized. The handover procedures described herein may additionally or alternatively be used to implicitly or explicitly handover UE device 10 between signal beams 66 of the same satellite (e.g., to implicitly update the serving beam of the serving satellite when the UE device moves between beams of the serving satellite without additional signaling overhead).

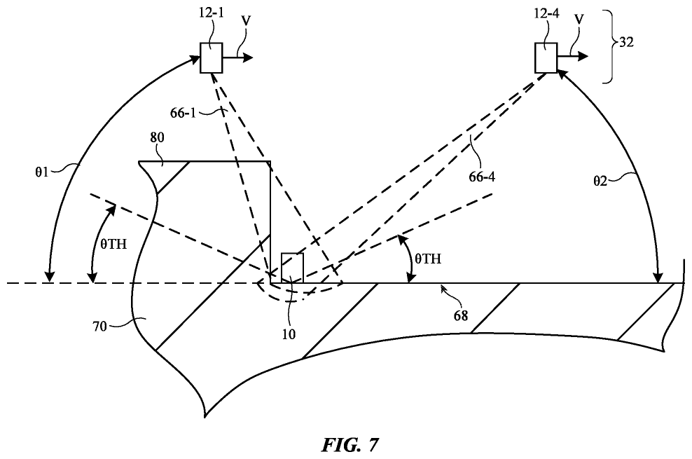

In practice, there may be scenarios where UE device 10 will be unable to communicate with gateway(s) 14 via the default satellite (or where the default satellite will otherwise offer insufficient wireless service for UE device 10). In these situations, a different satellite 12 may offer superior wireless capacity for the UE device. For example, as shown in FIG. 7, UE device 10 may be located at, adjacent, or near to an obstacle such as obstacle 80 on Earth. Obstacle 80 may be a hill, a mountain, a building, a tree, weather, or any other object or obstacle that may interfere with radio-frequency propagation between UE device 10 and space.

While at this location, satellite 12-1 in satellite constellation 32 has an elevation angle θ1, which may be the highest elevation angle of all visible satellites for UE device 10. As such, satellite 12-1 may be selected as the default serving satellite for UE device 10 (e.g., while processing the operations of FIG. 6). However, signal beam 66-1 of satellite 12-1 may be blocked by obstacle 80. This may interfere with the reception of DL signals at UE device 10 from satellite 12-1. UE device 10 may gather wireless performance metric data from the DL signals to characterize its own current channel conditions. UE device 10 may therefore use the wireless performance metric data to detect that satellite 12-1 is not providing UE device 10 with optimal wireless communications capabilities.

At the same time, satellite constellation 32 may include other visible satellites such as satellite 12-4. Satellite 12-4 may have a signal beam 66-4 overlapping UE device 10. Satellite 12-4 is at an elevation angle θ2, which is lower than the elevation angle θ1 of satellite 12-1. As such, satellite 12-4 is not selected as the serving satellite during the operations of FIG. 6. In situations such as these where the default satellite is blocked by obstacle 80, satellite 12-4 may be able to provide UE device 10 with superior wireless communications services than satellite 12-1. However, only UE device 10 has real-time knowledge of its channel conditions. The gateway(s) generally have no knowledge or outdated knowledge of the channel conditions at UE device 10. In these situations, UE device 10 may initiate an explicit handover operation from the current serving satellite (e.g., the default satellite such as satellite 12-1) to the different satellite (e.g., satellite 12-4).

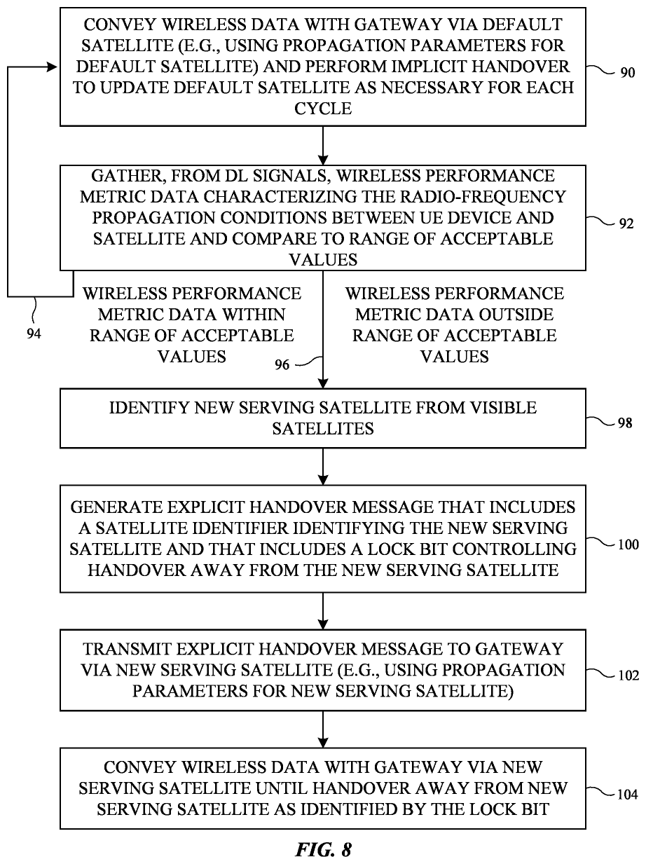

FIG. 8 is a flow chart of operations involved in using UE device 10 to perform an explicit handover operation. The operations of FIG. 8 may, for example, be performed once UE device 10 has begun communicating with one or more gateways 14 via its current default satellite (e.g., after operations 72-76 of FIG. 6 for a given cycle).

At operation 90, UE device 10 may convey wireless data with gateway(s) 14 via its current default satellite. UE device 10 may, for example, transmit a data packet to gateway(s) 14 via the current default satellite using its propagation parameters associated with the current default satellite and/or gateway(s) 14 may transmit a data packet to UE device 10 via the current default satellite using its propagation parameters associated with the current default satellite. As the satellites in satellite constellation 32 move over time, UE device 10 and gateway(s) 14 may perform implicit handover (e.g., iterations of the operations of FIG. 6) to update the serving satellite to any new default satellite for every upcoming cycle.

At operation 92, UE device 10 may gather wireless performance metric data from DL signals received from its serving satellite. Operation 92 may, for example, be performed concurrently with operation 90. The wireless performance metric data may characterize the radio-frequency channel conditions at UE device 10 (e.g., the radio-frequency propagation conditions between UE device 10 and its serving satellite). The wireless performance metric data may include any desired wireless performance metric information such as received signal power levels, signal-to-noise ratio (SNR) values, error rate values, noise floor values, etc. Since gateway(s) 14 are located remote from UE device 10, the gateway(s) may be unable to accurately estimate the current channel conditions for UE device 10.

UE device 10 (e.g., one or more processors on UE device 10) may compare the wireless performance metric data to a predetermined range of values (e.g., a range of acceptable values defined by an upper threshold limit and/or a lower threshold limit). When the wireless performance metric data falls within the range of acceptable values (e.g., below the upper threshold limit and/or above the lower threshold limit), this may be indicative of an optimal or unobstructed LOS path between UE device 10 and the default satellite. Processing may then loop back to operation 90 via path 94 and UE device 10 may continue to use the default satellite to communicate with gateway(s) 14. When the wireless performance metric data falls outside of the range of acceptable values (e.g., above the upper threshold limit or below the lower threshold limit), processing may proceed from operation 92 to operation 98 via path 96. The example of FIG. 8 is merely illustrative and, if desired, processing may jump from operation 90 to operation 98 whenever the radio-frequency channel condition at UE device 10 for communicating with its default satellite are insufficient.

At operation 98, UE device 10 may proactively initiate the explicit handover operation by identifying a new serving satellite from the set of visible satellites (e.g., as identified at operation 74 of FIG. 6 for each cycle). The new serving satellite may be any desired satellite that is visible to UE device 10 (or that will be visible during the next cycle). As one example, the new serving satellite may be a visible satellite having the second highest elevation angle. As another example, the new serving satellite may be a visible satellite having an elevation angle that is separated from the elevation angle of the current serving satellite by at least a predetermined margin or the visible satellite having an elevation angle farthest from the elevation angle of the current serving satellite (e.g., minimizing the likelihood that the new serving satellite will be obstructed by the same obstacle as the current serving satellite). In the example of FIG. 7, UE device 10 may, for example, select satellite 12-4 to serve as the new serving satellite.

At operation 100, UE device 10 may generate an explicit handover message. The explicit handover message may, for example, be a control message (e.g., a reverse link control message) when UE device 10 is in a registered state with the network and may be a signup message when UE device 10 is in an unregistered state with the network (e.g., when the communication link between UE device 10 and the network has been dropped or lost).

The explicit handover message may include a satellite identifier. The satellite identifier may identify which satellite 12 in satellite constellation 32 the UE device 10 has selected as the new serving satellite (e.g., each satellite in constellation 32 may have a unique identifier). The explicit handover message may also include a satellite lock indicator. The satellite lock indicator may be appended to the satellite identifier if desired. The satellite lock indicator may include one or more bits. In one implementation described herein as an example, the satellite lock indicator includes a single bit, sometimes referred to herein as lock bit LB. UE device 10 may use the lock bit to control how gateway(s) 14 perform a subsequent handover away from the new serving satellite in later processing. Since the lock bit is a single bit, transmitting the lock bit may consume as few transmission resources as possible.

At operation 102, UE device 10 may transmit the explicit handover message to gateway(s) 14 via the new serving satellite. UE device 10 may, for example, transmit the explicit handover message in reverse link UL signals that are transmitted using the propagation parameters for the new serving satellite relative to UE device 10 (e.g., in a control message or signup message).

At operation 104 (e.g., in a subsequent cycle), UE device 10 may begin to convey wireless data with gateway(s) 14 over the new serving satellite (e.g., the same gateway that served the previous serving satellite or a different gateway than the gateway that served the previous serving satellite). UE device 10 may, for example, transmit data packet(s) to gateway(s) 14 via the new serving satellite using its propagation parameters and/or may receive data packet(s) from gateway(s) 14 via the new serving satellite. UE device 10 may continue to convey wireless data with gateway(s) 14 over the new serving satellite until performing a handover operation away from the new serving satellite (e.g., the handover operation controlled by the lock bit in the explicit handover message). This handover operation away from the new serving satellite may be an implicit handover operation performed without additional control signaling overhead.

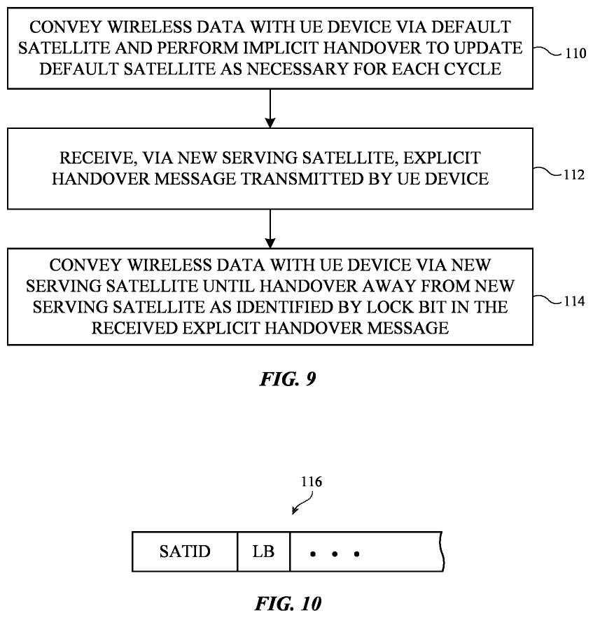

FIG. 9 is a flow chart of operations involved in using gateway(s) 14 to perform the explicit handover operation led by UE device 10. The operations of FIG. 8 may, for example, be performed once UE device 10 has begun communicating with gateway(s) 14 via its current default satellite (e.g., after operations 72-76 of FIG. 6 for a given cycle).

At operation 110, gateway(s) 14 may convey wireless data with UE device 10 via its current default satellite. Gateway(s) 14 may, for example, transmit a data packet to UE device 10 via the current default satellite using its propagation parameters associated with the current default satellite and/or gateway(s) 14 may receive a data packet from UE device 10 via the current default satellite. Operation 110 may, for example, be performed concurrently with operation 90 of FIG. 8. As the satellites in satellite constellation 32 move over time, UE device 10 and gateway(s) 14 may perform implicit handover (e.g., iterations of the operations of FIG. 6) to update the serving satellite to any new default satellite for every upcoming cycle without additional control signaling overhead.

At operation 112, gateway(s) 14 may receive an explicit handover message from UE device 10 via the new serving satellite (e.g., in reverse link DL signals relayed by the new serving satellite). Gateway(s) 14 may decode the satellite identifier and the lock bit from the explicit handover message. The gateway that receives the explicit handover message may be the same gateway that communicated during operation 110 or may be a different gateway.

At operation 114, gateway(s) 14 (e.g., the same gateway that communicated during operation 110 or a different gateway) may begin to convey wireless data with UE device 10 over the new serving satellite. Gateway(s) 14 may, for example, transmit data packet(s) to UE device 10 via the new serving satellite using its propagation parameters and/or may receive data packet(s) from UE device 10 via the new serving satellite. Gateway(s) 14 may continue to convey wireless data with UE device 10 over the new serving satellite until performing a handover operation away from the new serving satellite (e.g., as controlled/signaled by the lock bit in the explicit handover message).

FIG. 10 is a diagram of an illustrative explicit handover message that may be transmitted by UE device 10. As shown in FIG. 10, explicit handover message 116 may include a satellite identifier SATID associated with the new serving satellite and a lock bit LB appended to the satellite identifier. Explicit handover message 116 may be a control message or a signup message. Satellite identifier SATID and/or lock bit LB may be located in a payload field or a header field of explicit handover message 116. Explicit handover message 116 may include any other desired information or data.

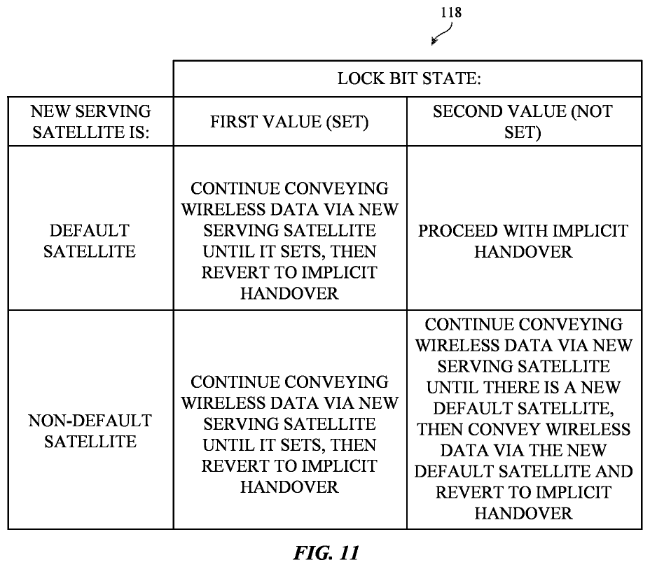

FIG. 11 includes a table 118 showing how UE device 10 and gateway(s) 14 may perform the handover operation away from the new serving satellite and to a subsequent serving satellite at the end of the explicit handover operation (e.g., while UE device 10 processes operation 104 of FIG. 8 and while gateway(s) 14 process operation 114 of FIG. 9). This handover operation may be an implicit handover operation that is triggered and controlled by UE device 10 via appropriate selection of lock bit LB in explicit handover message 116 (e.g., without any further control signaling overhead between UE device 10 and the gateway(s)).

In general, the handover operation depends upon the state of lock bit LB and whether the new serving satellite is the default satellite (e.g., the highest elevation angle visible satellite) for UE device 10 or a non-default satellite (e.g., for the upcoming cycle). UE device 10 and gateway(s) 14 will both have knowledge of whether the new serving satellite (e.g., as identified by the explicit handover message) is or will be the default satellite or a non-default satellite (e.g., from the ephemeris data, current location of UE device 10, and GPS time as processed during operations 72-76 of FIG. 6). UE device 10 may configure the state of lock bit LB to either have a first value (e.g., a set value) or a second value (e.g., an unset value) to control/trigger how the handover operation is performed. The first value for lock bit LB may be “1” or “0” whereas the second value may be whichever value the first value is not.

As shown in the first row and first column of table 118, when the new serving satellite is the default satellite and the lock bit has the first value (e.g., is set), UE device 10 and gateway(s) 14 may continue conveying wireless data via the new serving satellite until the new serving satellite sets. A visible satellite may be referred to as “setting” when the visible satellite moves to an elevation angle relative to UE device 10 that is less than threshold elevation angle θTH (e.g., when the visible satellite becomes a non-visible satellite). Once the new serving satellite sets, UE device 10 and gateway(s) 14 may revert to the implicit handover scheme of FIG. 6 to select the subsequent serving satellite for the upcoming cycle (e.g., the current default satellite may be selected as the subsequent serving satellite). Even when the new serving satellite is no longer the default satellite for UE device 10 (e.g., because a different visible satellite has moved to a position in which the visible satellite has the highest elevation angle for UE device 10), UE device 10 may continue to communicate via the new serving satellite until it is no longer visible.

In other words, gateway(s) 14 will assume, based on the set lock bit, that the UE device 10 wants to remain locked onto the new serving satellite so long as the new serving satellite remains visible. Since the UE device set the lock bit, the UE device also knows to remain locked onto the new serving satellite so long as the new serving satellite remains visible. This may, for example, help to preserve the continuity of communications between UE device 10 and gateway(s) 14 by allowing the UE device to continue communicating via the new serving satellite without risking loss of communications if the new default satellite is blocked by an obstacle such as obstacle 80 of FIG. 7.

As shown in the first row and second column of table 118, when the new serving satellite is the default satellite and the lock bit has the second value (e.g., is not set), UE device 10 and gateway(s) 14 may immediately revert to the implicit handover scheme of FIG. 6 to select the subsequent serving satellite for the upcoming cycle. As such, as soon as there is a new default satellite for UE device 10 (e.g., as soon as there is a visible satellite other than the new serving satellite that is at a highest elevation angle of all the visible satellites for UE device 10), UE device 10 and gateway(s) 14 may both independently and implicitly switch to communicating via the new default satellite (e.g., in the next cycle) without first waiting for the new serving satellite to set.

As shown in the second row and first column of table 118, when the new serving satellite is not the default satellite and the lock bit has the first value (e.g., is set), UE device 10 and gateway(s) 14 may continue conveying wireless data via the new serving satellite until the new serving satellite sets. Once the new serving satellite sets, UE device 10 and gateway(s) 14 may revert to the implicit handover scheme of FIG. 6 to select the subsequent serving satellite for the upcoming cycle. Even when the new serving satellite is no longer the default satellite for UE device 10 (e.g., because a different visible satellite has moved to a position in which the visible satellite has the highest elevation angle for UE device 10), UE device 10 may continue to communicate via the new serving satellite until it is no longer visible. In other words, gateway(s) 14 will assume, based on the set lock bit, that the UE device 10 wants to remain locked onto the new serving satellite so long as the new serving satellite remains visible. Since the UE device set the lock bit, the UE device also knows to remain locked onto the new serving satellite so long as the new serving satellite remains visible. By setting the lock bit, UE device 10 may force gateway(s) 14 lock to the new serving satellite and to continue communicating with UE device 10 via the new serving satellite until it sets, regardless of whether or not the serving satellite is or was ever the default satellite for UE device 10.

As shown in the second row and second column of table 118, when the new serving satellite is not the default satellite and the lock bit has the second value (e.g., is not set), UE device 10 and gateway(s) 14 may continue conveying wireless data via the new serving satellite until there is a new default satellite for UE device 10. Once there is a new default satellite (e.g., a new visible satellite having a higher elevation angle than all other visible satellites for UE device 10 other than the previous default satellite that caused UE device 10 to issue the explicit handover message), UE device 10 and gateway(s) 14 may then independently and implicitly begin to convey wireless data via the new default satellite (e.g., during the next cycle). Even if the new serving satellite has not yet set, UE device 10 and gateway(s) 14 may switch to the new default satellite as soon as it becomes the visible satellite with highest elevation angle for UE device 10. Then, UE device 10 and gateway(s) 14 may revert to the implicit handover operation of FIG. 6 to continue to update the serving satellite over time.

In other words, gateway(s) 14 will assume, based on the unset lock bit, that the UE device 10 does not want to remain locked onto the new serving satellite until the new serving satellite sets. Since the UE device transmitted the unset lock bit, the UE device also knows to switch to the new default satellite regardless of whether the new serving satellite remains visible. In summary, UE device 10 and gateway(s) 14 may perform implicit handover with no additional control signaling overhead. When needed given its current channel conditions, which are generally unknown to the gateway(s), UE device 10 may control, direct, or orchestrate explicit handover using the explicit handover message. After conveying wireless data over the new serving satellite, the lock bit may allow the gateway(s) and the UE device 10 to both switch away from the new serving satellite and to the same subsequent serving satellite implicitly and independently without further control signaling overhead. This may allow UE device 10 and the rest of the network to establish and maintain a continuous wireless link over time even as the channel conditions at UE device 10 change and as the satellites 12 in constellation 32 move over time.

One or more elements described herein (e.g., UE devices 10, satellite 12, gateway 14, CN 20, etc.) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A method of operating an electronic device to communicate with one or more gateways via a constellation of communication satellites, the method comprising:
during a first cycle, receiving first wireless data relayed by a first communication satellite in the constellation;
transmitting, to the one or more gateways via a second communication satellite in the constellation, a message having an identifier associated with the second communication satellite, the second communication satellite being at a lower elevation angle than the first communication satellite; and
during a second cycle subsequent to the first cycle, transmitting second wireless data to the one or more gateways via the second communication satellite.

2. The method of claim 1, wherein the message comprises a lock identifier.

3. The method of claim 2, wherein the lock identifier comprises a lock bit.

4. The method of claim 3, wherein the lock bit is appended to the identifier associated with the second communication satellite.

5. The method of claim 2, further comprising:
when the lock identifier has a first value, transmitting, via the second communication satellite, third wireless data until the second communication satellite sets relative to the electronic device and, once the second communication satellite has set relative to the electronic device, transmitting during a third cycle, via a third communication satellite in the constellation, fourth wireless data.

6. The method of claim 5, wherein the third communication satellite has, during the third cycle, a highest elevation angle, relative to the electronic device, of non-geostationary communication satellites in the constellation.

7. The method of claim 5, further comprising:
when the lock identifier has a second value that is different from the first value, transmitting, prior to the second communication satellite setting relative to the electronic device, the third wireless data to the third communication satellite, wherein the third communication satellite has a highest elevation angle, relative to the electronic device, of non-geostationary satellites in the constellation.

8. The method of claim 2, wherein the lock identifier is configured to signal, to the one or more gateways, that the electronic device will continue communicating with the one or more gateways via the second communication satellite until the second communication satellite has an elevation angle, relative to the electronic device, that is less than a threshold elevation angle.

9. The method of claim 2, wherein the message comprises a signup message.

10. The method of claim 2, wherein the message comprises a control message.

11. The method of claim 1, further comprising:
generating wireless performance metric data based on the first wireless data; and
transmitting the message when the wireless performance metric data is outside a predetermined range of values.

12. A method of operating one or more gateways to communicate with an electronic device via a constellation of communication satellites, the method comprising:
during a first cycle, transmitting first wireless data to the electronic device via a first communication satellite in the constellation;
receiving, from the electronic device, a message transmitted by the electronic device and relayed by the constellation; and
during a second cycle subsequent to the first cycle, transmitting, to the electronic device and via a second communication satellite identified by the message, second wireless data.

13. The method of claim 12, further comprising:
when a bit in the message has a first value, waiting until the second communication satellite has set relative to the electronic device and then transmitting third wireless data to the electronic device via a third communication satellite in the constellation; and
when the bit in the message has the second value, transmitting the third wireless data to the electronic device via the third communication satellite without waiting until the second communication satellite has set relative to the electronic device.

14. The method of claim 13, wherein the third communication satellite has a highest elevation angle, relative to the electronic device, of non-geostationary satellites in the constellation.

15. The method of claim 12, wherein the first communication satellite has, during the first cycle, a highest elevation angle, relative to the electronic device, of non-geostationary satellites in the constellation.

16. The method of claim 15, further comprising:
during a third cycle prior to the first cycle, transmitting third wireless data to the electronic device via a third communication satellite in the constellation, wherein the third communication satellite has, during the third cycle, the highest elevation angle, relative to the electronic device, of the non-geostationary satellites in the constellation.

17. A method of operating an electronic device to communicate with one or more gateways via a set of communication satellites, the method comprising:
during a first cycle, transmitting, to a first communication satellite in the constellation and using a first propagation parameter associated with the first communication satellite, first wireless data, wherein the first communication satellite has, during the first cycle, a highest elevation angle, relative to the electronic device, of the communication satellites in the set; and
during a second cycle following the first cycle, transmitting, to a second communication satellite in the constellation and using a second propagation parameter associated with the second communication satellite, second wireless data, wherein the second communication satellite has, during the second cycle, the highest elevation angle, relative to the electronic device, of the communication satellites in the set.

18. The method of claim 17, further comprising:
transmitting, to the one or more gateways and via a third satellite in the set, an explicit handover message that instructs the one or more gateways to communicate with the electronic device via the third communication satellite during a third cycle subsequent to the second cycle.

19. The method of claim 18, wherein the communication satellites in the set are non-geostationary satellites.

20. The method of claim 18, wherein the message comprises an identifier that identifies the third communication satellite and wherein the message comprises a lock bit.
